(19) United States
(12) Patent Application Publication
(10) Pub. No.: US 2008/0088718 A1
(43) Pub. Date: Apr. 17, 2008

(54) Template Creator For Digital Cameras

(76) Inventors: Robert P. Cazier, Johnstown, CO (US); Murray Dean Craig, Johnstown, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/550,095

(22) Filed: Oct. 17, 2006

(51) Int. Cl. H04N 5/262

(52) U.S. Cl. 348/239

(57) ABSTRACT

Systems and methods are disclosed for applying cutout effects to digital images. An exemplary method of applying user-generated templates to a digital image on a camera may comprise converting at least a portion of a first digital image to a template for use on a second digital image based at least in part on user input. The method may also comprise fitting a second digital image to the template. The method may also comprise rendering a final image by populating pixel values with either a pixel value for the template or a pixel value for the second digital image.

### BACKGROUND

Conventional film and more recently, digital cameras, are widely commercially available, ranging both in price and in operation from sophisticated single lens reflex (SLR) cameras used by professional photographers to inexpensive “point-and-shoot” cameras that nearly anyone can use with relative ease. Digital cameras are available with user interfaces that enable a user to select various camera features (e.g., ISO speed and red-eye removal).

Little or nothing is commercially available for allowing the user to create custom templates on their camera from their own photographs. If the camera is provided with any sort of effects, these are typically limited to “canned” effects, such as borders that are stored in the camera's memory by the manufacturer. However, these canned effects are generic (e.g., a tree border that can be applied to outdoor photographs, a wedding bells border that can be applied to wedding photographs, etc.). The camera user may seldom (or even never) use these canned effects for their own photographs. Accordingly, these canned effects provide little added value for the camera user while consuming limited memory resources on the camera.

### BRIEF DESCRIPTION OF THE DRAWINGS

FIG. 1 is a block diagram of an exemplary camera system which may implement a template creator.

FIG. 2 are illustrations of digital images showing an exemplary embodiment for using a template creator in a digital camera to produce a border effect.

FIG. 3 are illustrations of digital images showing another exemplary embodiment for using a template creator in a digital camera to produce an overlay effect.

FIG. 4 are digital images showing another exemplary embodiment for using a template creator in a digital camera to produce a transparency effect.

FIG. 5 are illustrations of digital images showing another exemplary embodiment for using a template creator in a digital camera to produce a tiled effect.

FIG. 6 are illustrations of digital images showing another exemplary embodiment for using a template creator in a digital camera to produce a signature effect.

FIG. 7 is a flowchart illustrating exemplary operations to implement a template creator in digital cameras.

### DETAILED DESCRIPTION

Systems and methods are disclosed for creating templates in a digital camera. In an exemplary embodiment, a first image is converted to a template image. A second image may then be combined with the template image. For example, the first image may be tiled to form a border or frame template and then the second image may be fitted in the border or frame template. Or for example, a portion of the first image may be made partially transparent. This template may be used as a border when overlaid on other images, or it may be the user's signature so that overlaying the template on another image allows the user to “sign” their photographs. The user may store the template image for repeated or later use. Accordingly, the user is given more creative options for editing their photographs directly on the camera itself without the need to store canned borders in the camera's memory.

Exemplary systems may be implemented as an easy-to-use user interface displayed on the digital camera and navigated by the user with conventional camera controls (e.g., arrow buttons and zoom levers already provided on the camera). The user needs little, if any, knowledge about photo-editing, and does not need special software for their PC to create these templates. Accordingly, the user can be creative in generating and applying templates to their digital photographs directly on the camera itself.

### Exemplary Systems

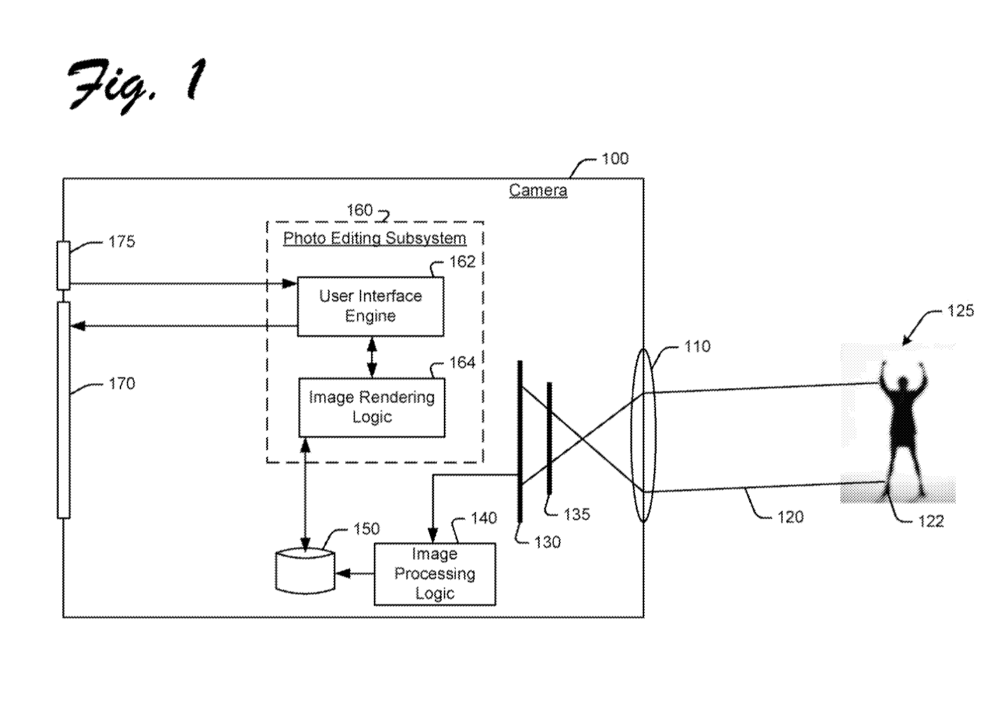

FIG. 1 is a block diagram of an exemplary camera system which may implement a template creator. The exemplary camera system may be a digital camera 100 including a lens 110 positioned to focus light 120 reflected from one or more objects 122 in a scene 125 onto an image capture device or image sensor 130 when a shutter 135 is open (e.g., for image exposure). Exemplary lens 110 may be any suitable lens which focuses light 120 reflected from the scene 125 onto image sensor 130.

Exemplary image sensor 130 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 130 may include, but is not limited to, a charge-coupled device (CCD), or a complementary metal oxide semiconductor (CMOS) sensor.

Camera system 100 may also include image processing logic 140. In digital cameras, the image processing logic 140 receives electrical signals from the image sensor 130 representative of the light 120 captured by the image sensor 130 during exposure to generate a digital image of the scene 125. The digital image may be stored in the camera's memory 150 (e.g., a removable memory card).

Shutters, image sensors, memory, and image processing logic, such as those illustrated in FIG. 1, are well-understood in the camera and photography arts. These components may be readily provided for digital camera 100 by those having ordinary skill in the art after becoming familiar with the teachings herein, and therefore further description is not necessary.

Digital camera 100 may also include a photo-editing subsystem 160. In an exemplary embodiment, photo-editing subsystem 160 is implemented in program code (e.g., firmware and/or software) residing in memory on the digital camera 100 and executable by a processor in the digital camera 100, such as the memory and processor typically provided with commercially available digital cameras. The photo-editing subsystem 160 may include user interface engine 162 and image rendering logic 164 for producing templates in the digital camera.

The image rendering logic 164 may be operatively associated with the memory 150 for accessing digital images (e.g., reading the images stored in memory 150 by image processing logic 140 or writing the images generated by the image rendering logic 164). Image rendering logic 164 may include program code for generating templates from the user's digital photographs and using the templates with the user's other digital images stored on the camera 100, as will be explained in more detail below. The image rendering logic 164 may also be operatively associated with the user interface engine 162.

User interface engine 162 may be operatively associated with a display 170 and one or more camera controls 175 already provided on many commercially available digital cameras. Such an embodiment reduces manufacturing costs (e.g., by not having to provide additional hardware for implementing the photo-editing subsystem 160), and enhances usability by not overwhelming the user with additional camera buttons.

During operation, the user interface engine 162 displays a menu on the digital camera (e.g., on display 170). In an exemplary embodiment, the menu may be accessed by a user selecting the “Design Gallery” menu option. The menu may then be navigated by a user making selections from any of a variety menus options. For example, the user interface engine 162 may receive input (e.g., via one or more of the camera controls 175) identifying user selection(s) from the menu for a type of template (e.g., tiled images, cutout, vignette, etc.). The image rendering logic 164 may then be implemented to produce the template and apply it using digital images stored in the digital camera 100 (e.g., in memory 150) based on user selection(s) from the menu.

A preview image may be displayed on display 170 so that the user can see what the template looks like and/or what a photograph will look like with the template. Optionally, instructive text may also be displayed on display 170 for modifying, or accepting/rejecting the template. The instructive text may be displayed until the user operates a camera control 175 (e.g., presses a button on the digital camera 100). After the user operates a camera control 175, the text may be removed so that the user can better see the preview image and templates on display 170.

Also optionally, the user may operate camera controls 175 (e.g., as indicated by the instructive text) to modify the template. For example, the user may press the left/right arrow buttons on the digital camera 100 to change the template (e.g., increase/decrease the size, select between color and black/white, etc.).

In an exemplary embodiment, a copy of the original digital photograph is used for producing the template from an image stored on the digital camera 100. For example, the template may be viewed by the user on display 170 directly after the original image so that the user can readily see both the original image and the template.

Before continuing, it is noted that the digital camera 100 shown and described above with reference to FIG. 1 is merely exemplary of a camera which may implement a template creator. The systems and methods described herein, however, are not intended to be limited only to use with the digital camera 100. Other embodiments of cameras and/or systems which may implement the template creator are also contemplated.

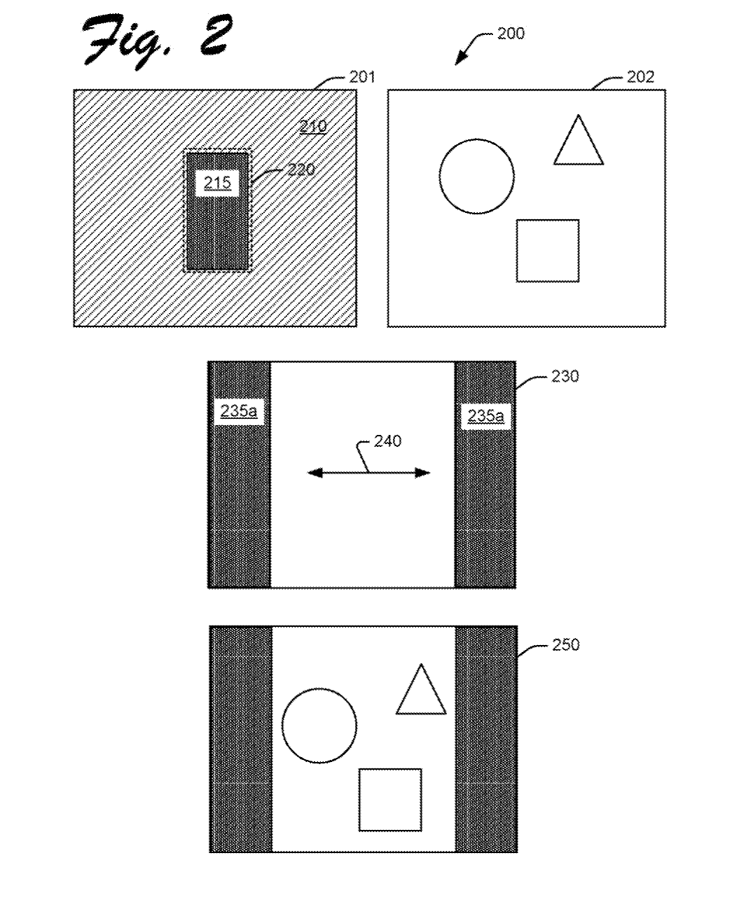

FIG. 2 are illustrations of digital images 200 showing an exemplary embodiment for using a template creator in a digital camera to produce a border effect. In this embodiment, the camera user captures a first digital photograph 201 of a scene 210. The camera user may then select all or a portion of the scene 210 as an area of interest 215. The area of interest 215 may be a particular pattern (as illustrated in FIG. 2), a texture, an object (e.g., a tree, a pinecone, an animal, a person), etc.

It is noted that the area of interest 215 may be selected using any of a wide variety of techniques, now known or later developed. By way of example, a selection tool 220 (e.g., a box or other shape) may be displayed for the user on the camera display. The user may then use camera controls (e.g., up/down and right/left arrow buttons on the camera) to position the selection tool 220 in the scene 210 over the area of interest 215. Optionally, the user may also use camera controls (e.g., the zoom lever) to increase/decrease the size of the selection tool 220. Still other embodiments may include automatically selecting the area of interest 215, e.g., using subject recognition algorithms.

The area of interest 215 may be used to generate a template 230. In this example, the template 230 includes borders 235a-b. In an exemplary embodiment, pixels values for the area of interest 215 may be used to populate pixels in the template 230 corresponding to the desired border(s) 235a-b.

Various user options for customizing the template 230 may be provided to the user through a menu system displayed via the user interface on the digital camera. For example, the user may resize the border(s) 235a-b, as indicated by arrows 240. Other examples for customizing the template may include applying color schemes, fading, sizing the subject within the border, and/or other photo effects.

The template 230 may be stored in the camera on a temporary, semi-permanent, or permanent basis. For example, the template 230 may be erased after its first use to preserve memory resources. Or for example, the template 230 may be stored for repeated use.

The camera user may apply the template 230 to a second digital photograph 202 on the camera itself. In an exemplary embodiment, the second digital photograph 202 may be resized to fit within the border(s) 235a-b of template 230, as illustrated by the rendered image 250. Alternatively, the template may be overlaid onto the second digital photograph 202, thereby cropping a portion of the second digital photograph 202.

There are a wide variety of techniques for combining digital images, such as the template 230 and second digital photograph 202 to render a digital image comprising components of each. In an exemplary embodiment, the rendered image 250 may be a new digital image produced by populating pixels in the rendered digital image 250 with pixel values for the borders 235a-b in the template 230, and populating the remaining pixels in the rendered digital image 250 with pixel values from the second digital photograph 202. Such an embodiment does not irreversibly change the template 230 or the second digital photograph 202 and enables the template 230 to be retained for later use. However, other techniques for combining the template 230 with the second digital photograph 202 are also contemplated.

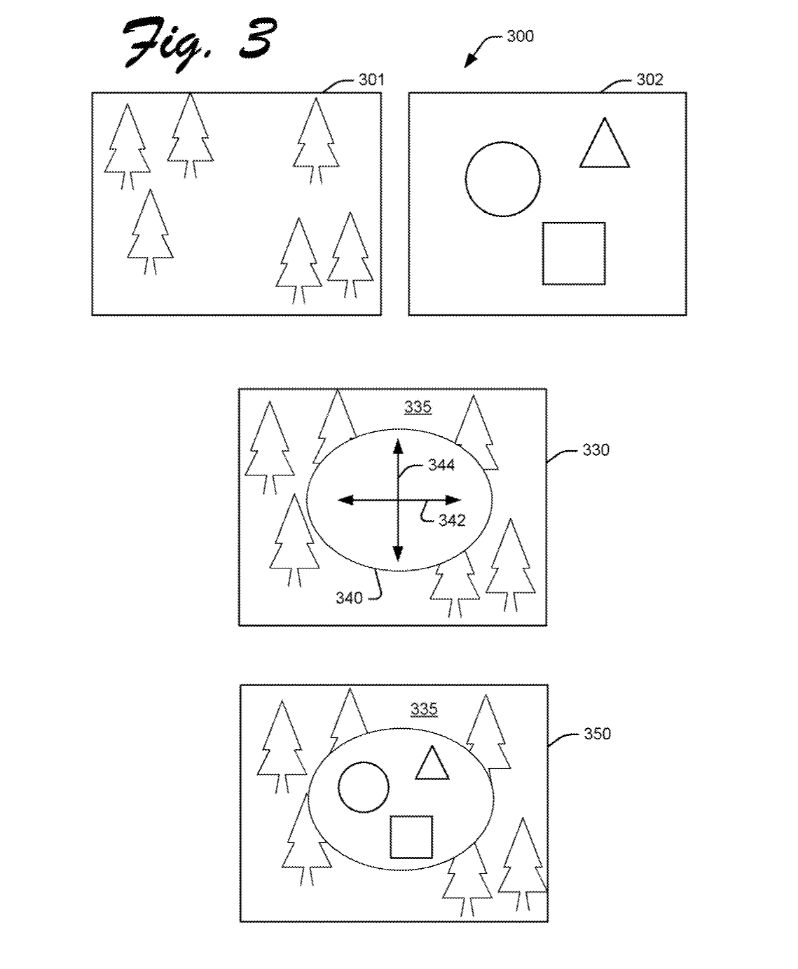

FIG. 3 are illustrations of digital images 300 showing another exemplary embodiment for using a template creator in a digital camera to produce an overlay effect. In this embodiment, the camera user captures a first digital photograph 301 of a scene 310. The camera user may then select all or a portion of the scene 310 as an area of interest. In this example, the camera user has selected the entire photograph 301 as the area of interest.

The area of interest may then be used to generate a template 330. In this example, the template 330 includes the area of interest in the first digital photograph 301 as a backdrop 335. A window 340 may be provided for adding another image (e.g., a second digital photograph 302) as a foreground image. Optionally, the user may customize the template 330. For example, the user may resize the window 340 (as illustrated by arrows 342 and 344), or change the coloring of the backdrop 335 (e.g., to grayscale) to highlight the foreground image.

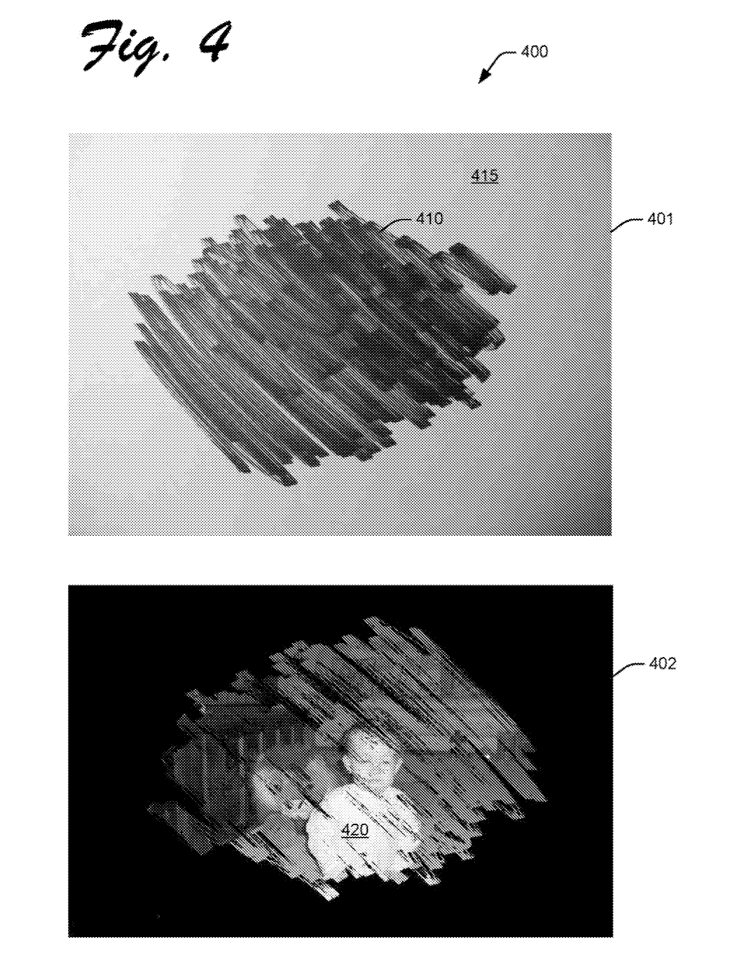

The camera user may then apply the template 330 to a second digital photograph 202 to produce a rendered image 350 with a second digital photograph 302 overlaid on the backdrop 335. The user may also apply various degrees of shading, and/or apply other photo effects to the second digital photograph fitted within the window 340. For example, controls may be provided for the user to change the level of transparency between the background image and the foreground image such that more or less of the background image shows through. An example of a transparency effect is described in more detail with reference to FIG. 4.

FIG. 4 are digital images 400 showing another exemplary embodiment for using a template creator in a digital camera to produce a transparency effect. In this example, the camera user captured a first digital photograph 401 of markings 410 on a piece of paper 415.

The template may be generated by driving all pixels in the template to either to an opaque color or to a transparent color. The color is chosen due to the nearness of the idea of black and white. In other words if a pixel is dark it will be made one color, while if a pixel is lighter it will be made transparent. The combination of the two layers is accomplished by searching for the transparent color in the template plane. If the pixel value is transparent, the background image is allowed to “show through”. If the pixel value is opaque, the appropriate color is selected so that the scene 420 of another digital photograph shows through in the rendered digital image 402.

Optionally, controls may be provided for the user to change the level of transparency between the background image and the foreground image such that more or less of the background image shows through. In another example, the template may be inverted to reverse the transparent and opaque areas. The coloring of the template may also be changed.

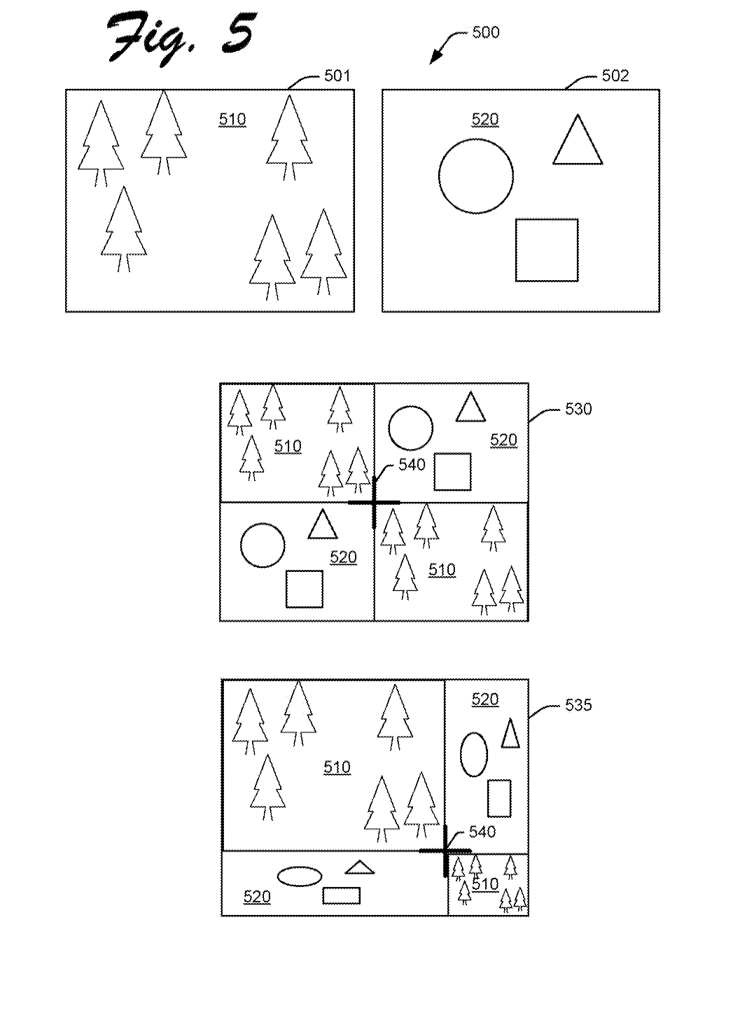

FIG. 5 are illustrations of digital images 500 showing another exemplary embodiment for using a template creator in a digital camera to produce a tiled effect. In this embodiment, the camera user captures a first digital photograph 501 of a scene 510 and a second digital photograph of another scene 520. The scenes 510 and 520 (and optionally more scenes from other digital photographs) are combined using a template with a vertical and horizontal split to produce the tiled effect shown in digital images 530 and 535.

The horizontal and vertical location may be controlled using a “cross-hair” 540 displayed for the user on the camera display. The “cross-hair” may be moved around the image to select the location for the vertical and horizontal split. A tertiary mechanism may be implemented to invert the combination of images (e.g., so the left image becomes the right image, and the right image becomes the left image and so forth).

Other embodiments may include a side-by-side arrangement (e.g., vertical split), top-to-bottom arrangement (e.g., horizontal split), additional tiles, etc. Optionally, the user may also apply various degrees of shading, and/or other photo effects to the images.

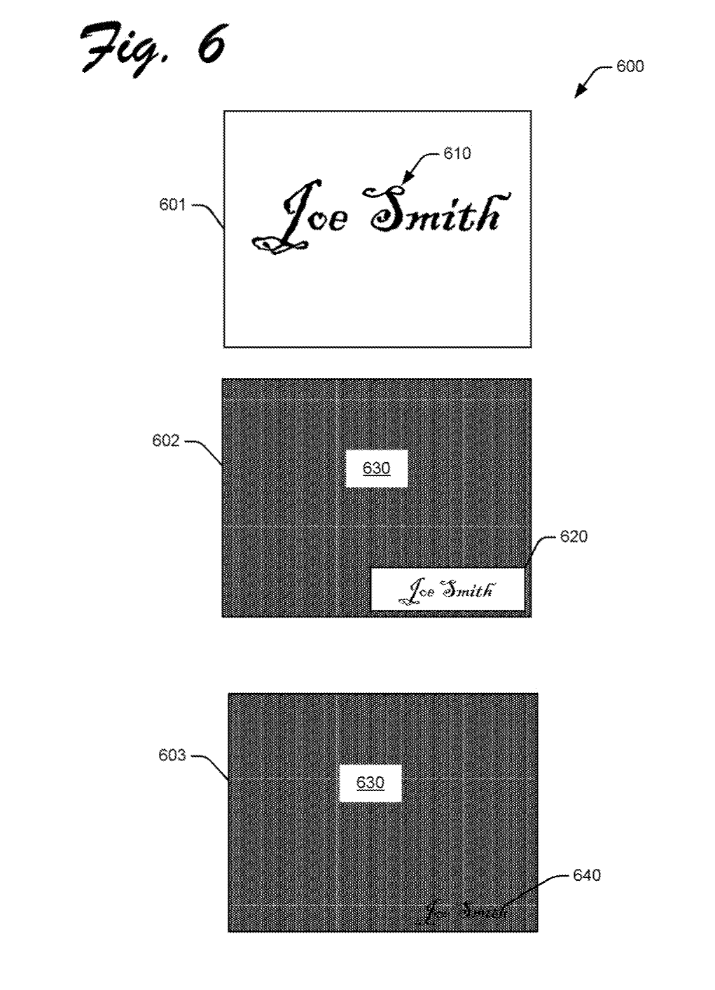

FIG. 6 are illustrations of digital images 600 showing another exemplary embodiment for using a template creator in a digital camera to produce a signature effect. In this embodiment, the camera user captures a first digital photograph 601 of his or her signature 610 for use as a template. In other exemplary embodiments, the signature 610 may be captured using a touch-screen display on the camera itself. Alternatively, the signature 610 may be captured using a separate device and then transferred to memory on the camera.

In addition to resizing the signature 610 for use as a template, the background pixels around the letters in the signature are made transparent so that the signature does not appear as a “block” 620 pasted on the scene 630, as illustrated by digital image 602. Instead, the template 640 appears on the scene 630 as if the photograph is “signed” by the user, as shown by digital image 603.

In exemplary embodiments, the intensity and/or color of the signature may be adjusted for the digital photographs. For example, the signature may be lightened if the digital photograph is dark. Likewise, the signature may be softened, blurred, and/or blended so that the signature appears more natural. Or for example, the color of the signature may be changed from blue to white when it is placed over blue sky in the scene. These adjustments may be made manually by the user and/or automatically (e.g., using scenery and color detection algorithms).

Optionally, the pixel data which is overlaid with the signature may be stored so that the user can later remove the signature and restore the original digital photograph without the signature. In an exemplary embodiment, the pixel data is stored as meta-data in the digital image header so that the original digital photograph can be restored even after the image has been transferred from the digital camera (e.g., to a personal computer or other storage device).

It is noted that the examples described above with reference to the figures are not intended to be limiting. Still other embodiments for generating and using templates on a digital camera to produce various effects for a user's digital photographs are also contemplated. For purposes of illustration, another template may include a double exposure, edge-to-edge deviation effect. In an exemplary embodiment, the double exposure has deviations based on the geometry of the picture. That is, instead of mixing the two pictures evenly throughout to get a percentage of both pictures (e.g., 50%-50%, 80-20, 60-40, etc.), another control is added whereby the deviation may be controlled such that the pictures are combined differently along the x or y axes (or both) as one traverses the images. Controls (right/left or up/down) are provided that allow the user to set the details of the variation. For example the mixing ratios set all the way to the right would take the maximum of one picture on the left, and the maximum of the other picture on the right. As one traverses from left to right, the relative picture ratios will vary.

By way of further illustration, another template may include a vignette double exposure effect. In an exemplary embodiment, a vignette may be applied to such that a percentage variation of the two pictures is based on the distance from the center. The edge contains a maximum of one picture. The center contains picture data with a maximum of the other picture. The controls allow the size of the vignette, or where it starts, to be adjusted. Another control allows for effect inversion such that the images are reversed in the order in which they are considered. This effectively “swaps” the interior image the exterior image for the vignette effect. A last control adjusts the details of the vignette. For example the maximum blend may be set such that the blend is not one hundred percent of one picture at the edge.

By way of further illustration, another template may include a random shape mixer effect. In an exemplary embodiment, random shapes are generated and applied where the shapes may be seen as transparent. The location and details of the shape are random. The shape is used as a cutout tool to see the layer underneath.

Still other embodiments are also contemplated for using templates in digital cameras as will be readily appreciated by those having ordinary skill in the art after becoming familiar with the teachings herein.

### Exemplary Operations

Exemplary operations which may be used to produce templates in digital cameras may be embodied as logic instructions on one or more computer-readable medium. When executed on a processor (e.g., in the camera), the logic instructions implement the described operations. In an exemplary embodiment, the components and connections depicted in the figures may be implemented.

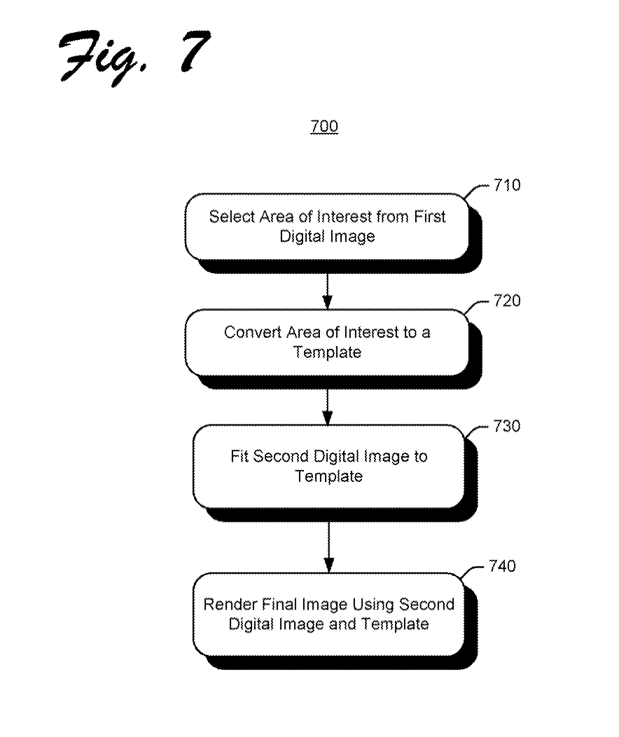

FIG. 7 is a flowchart illustrating exemplary operations 700 to implement a template creator in digital cameras. In operation 710, an area of interest may be selected from a first digital image. For example, the area of interest may be selected based on user input (using a cursor, menu selections, etc.). Or for example, the area of interest may be automatically selected (using subject recognition algorithms).

In operation 720, the area of interest may be converted to a template for use on a second digital image. In operation 730, the second digital image may be fitted to the template. In an exemplary embodiment, the area of interest may be used to produce a border effect and the second digital image may be fitted within the border. In another exemplary embodiment, the area of interest may be used to produce a signature for the user which is then applied to the user's digital photographs. Still other embodiments are also contemplated.

In operation 740, the final image may be rendered using the second digital image and the template. In an exemplary embodiment, the final image may be rendered by populating pixel values with either a pixel value for the border or a pixel value for the second digital image so that the final image shows the second digital image fitting within the border, or overlaying the digital photograph (e.g., for a signature effect).

Other operations, not shown, are also contemplated and will be readily apparent to those having ordinary skill in the art after becoming familiar with the teachings herein. For example, a separate copy of the digital image may be stored in memory before using the selected digital image to create a template. Accordingly, the user can revert back to the original digital image if the user decides that they do not like the template without having to undo all of the changes.

Also in an exemplary embodiment, operations may be executed using a smaller image size to speed up processing on the camera. For example, the image size used for generating the template and fitting the digital image to the template may be based on the size of the display on the digital camera (e.g., 1/70th the size of an actual image). Adjustments may be accomplished in real time using the smaller size images and then applied to the actual size images when the user is satisfied with the rendered image.

It is noted that the exemplary embodiments shown and described are provided for purposes of illustration and are not intended to be limiting. Still other embodiments for implementing a template creator in digital cameras are also contemplated.

1. A digital camera system comprising:
computer-readable storage for storing a first image and a second image in the digital camera;
image rendering logic executing in the digital camera to generate a custom template using the first image for the second image, the image rendering logic:
converting at least a portion of the first image to a template based at least in part on user input;
fitting the second image to the template; and
populating pixel values in a third image with either a pixel value for the template or a pixel value for the second digital image.

2. The digital camera system of claim 1, wherein the image rendering logic adjusts the template based on user input.

3. The digital camera system of claim 1, wherein the image rendering logic renders real-time output to the user by using a smaller image for changes.

4. The digital camera system of claim 3, further comprising:
receiving a user input by a user interface engine; and
saving the changes by the image rendering logic to an actual size image only if the user input indicates the user is satisfied with the rendered image.

5. The digital camera system of claim 1, wherein the image rendering logic stores pixel data hidden by the template in a header for the rendered image so that an original image can be restored even after the rendered image has been transferred from the digital camera.

6. The digital camera system of claim 1, wherein the image rendering logic generates a border template from the first digital image.

7. The digital camera system of claim 1, wherein the image rendering logic generates an overlay template from the first digital image.

8. The digital camera system of claim 1, wherein the image rendering logic generates a transparency template from the first digital image.

9. The digital camera system of claim 1, wherein the image rendering logic generates a signature template from the first digital image.

10. A method of applying user-generated templates to a digital image on a camera, comprising:
converting at least a portion of a first digital image to a template for use on a second digital image based at least in part on user input;
fitting a second digital image to the template; and
rendering a final image by populating pixel values with either a pixel value for the template or a pixel value for the second digital image.

11. The method of claim 10, further comprising selecting an area of interest from the first digital image for converting to the template.

12. The method of claim 11, wherein the area of interest is selected by the user.

13. The method of claim 11, wherein the area of interest is selected automatically on the camera.

14. The method of claim 10, further comprising generating a border template from the first digital image.

15. The method of claim 10, further comprising generating an overlay template from the first digital image.

16. The method of claim 10, further comprising generating a transparency template from the first digital image.

17. The method of claim 16, further comprising blending the first digital image and the second digital image to render a double-exposure effect.

18. The method of claim 10, further comprising generating a signature template from the first digital image.

19. A method of applying user-generated borders to a digital image on a camera comprising:
selecting an area of interest from a first digital image based on user input;
converting the area of interest to a border for use on a second digital image;
reconfiguring the second digital image to fit within the border; and
rendering a final image by populating pixel values with either a pixel value for the border or a pixel value for the reconfigured second digital image so that the final image shows the second digital image fitting within the border.

20. The method of claim 19, wherein the border is at least partially transparent.

21. The method of claim 19, further comprising changing the template based on user input to further customize the template for the user.
